(19) United States
(12) Patent Application Publication
(10) Pub. No.: US 2008/0044656 A1
(43) Pub. Date: Feb. 21, 2008

(54) Carbonaceous composite particles and uses and preparation of the same

(75) Inventors: Tse-Hao Ko, Taichung (TW); Jia-Hung Wei, Taichung (TW)

Correspondence Address: VENABLE LLP, P.O. BOX 34385, WASHINGTON, DC, 20043-9998, US

(73) Assignee: Feng Chia University, Taichung (TW)

(21) Appl. No.: 11/543,150

(22) Filed: Oct. 5, 2006

(30) Foreign Application Priority Data
Aug. 16, 2006 (TW) 095130063

(51) Int. Cl. H01M 4/58; H01B 1/04; B32B 5/16

(52) U.S. Cl. 428/403; 429/231.8; 252/502; 428/408

(57) ABSTRACT

A carbonaceous composite particle comprises a graphite particle and a layer of amorphous carbon structure covering the graphite particle, wherein the graphite particle is a graphitized mesocarbon microbead, a natural graphite particle, or a synthesized graphite particle. The composite particle is useful in a secondary cell, and is useful in providing a lithium-ion secondary cell having both a high charge capacity and a low irreversible capacity.

### CROSS-REFERENCES TO RELATED APPLICATIONS

This application claims priority to Taiwan Patent Application No. 095130063 filed on Aug. 16, 2006.

### STATEMENT REGARDING FEDERALLY SPONSORED RESEARCH OR DEVELOPMENT

Not applicable.

### BACKGROUND OF THE INVENTION

1. Field of the Invention

The subject invention relates to carbonaceous composite particles, their preparation methods and uses. The subject invention especially relates to a composite particle comprising a graphitized mesocarbon microbead, a natural graphite particle, or a synthesized graphite particle, its preparation method, and its use in a lithium-ion secondary cell.

2. Descriptions of the Related Art

As technology improves, electronics, information and communication products have also become more portable. Thus, it is desireable for all elements to be light, thin, short and small. In addition, the demand on electrical supply power performance is greatly increased. Given the above, it is necessary to develop a reusable energy storage system with a high energy density to replace conventional cells.

Among various energy storage systems, lithium-ion secondary cells with high energy density, high voltage, and long service lives are most widely used in portable electronic products. Prior lithium-ion secondary cells have utilized lithium metals as the cathode. Although these cells have a high energy density, dendritic crystals are deposited on the cathode after many charges and discharges. These deposited crystals penetrate the separating membrane, and thus, causes a short circuit between the anode and cathode and reduces the service life of the cell.

To prevent the dentritic crystals from depositing, many substituents are continuously developed to replace lithium metals as the cathode material. So far, in lithium-ion secondary cells, synthesized graphite or natural graphite has been widely used as the standard cathode material. However, there are some drawbacks in using synthesized graphite or natural graphite as the standard cathode material in lithium-ion secondary storage cells. First, these commercial lithium-ion secondary cells comprising synthesized graphite electrodes have very low lithium volumes. Second, the graphite products used in current lithium-ion secondary cells have attained the theoretic limit of energy storage (372 mAh/g). Therefore, an improved electrode material is desired to ameliorate the operating characteristics of the lithium-ion secondary cells to provide higher energy density, higher reversible capacity, and higher initial charge and discharge efficiency.

U.S. Pat. No. 6,316,146, assigned to Watanabe et al., discloses the use of thermoplastic novolac phenol resin and powder pitch as the raw materials that were mixed at 130□ and subjected to carbonization to provide an amorphous carbon structure material with an initial discharge capacity of up to 570 mAh/g. Although this carbon material has an initial discharge capacity higher than the theoretic value of 372 mAh/g, its irreversible capacity reaches up to 100 mAh/g and thus, is unable to provide a long service life for the cell.

Japanese Patent Publication Nos. JP 09-151328 and JP 2004137505 disclose that the usage of coal-tar pitch as the raw material to produce mesocarbon microbeads (“MCMB”). The mesocarbon microbeads were subjected to carbonization and graphitization to provide graphitized mesocarbon microbeads for manufacturing the carbon electrode of the lithium-ion secondary cell.

The subject invention focuses on the improvement of the current lithium-ion secondary cell to provide a carbonaceous composite particle for use as the cathode material of the lithium-ion secondary cell. By using the carbonaceous composite particle, the efficiency of the lithium-ion secondary cell is enhanced and provides the lithium-ion secondary cell with a high capacity and a low irreversible capacity, both of which are qualities that meet the requirements in the market.

### SUMMARY OF THE INVENTION

One objective of the subject invention is to provide a carbonaceous composite particle that comprises a graphite particle and a layer of amorphous carbon structures that cover the graphite particle. The graphite particle can be a graphitized mesocarbon microbead, a natural graphite particle, or a synthesized graphite particle. The size of the composite particle is preferably no more than 200 μm, more preferably, no more than 100 μm, and most preferably, no more than 40 μm.

Another objective of the subject invention is to provide a method for manufacturing a carbonaceous composite particle comprising the following steps:

(a) mixing a plurality of carbonaceous particles and an amorphous carbon structure (ACS)-forming material, wherein the carbonaceous particle is the same or different from each other and is either a mesocarbon microbead or a graphite particle, while the graphite particle is either a graphitized mesocarbon microbead, a natural graphite particle, or a synthesized graphite particle;

(b) conducting a first heat treatment under a temperature that is not higher than the pyrolysis temperature of the ACS-forming material; and

(c) conducting a second heat treatment under an oxygen deficient atmosphere;

wherein a crushing treatment is conducted before and/or after the second heat treatment step (c).

A further objective of the subject invention is to provide a secondary cell. The secondary cell comprises a first electrode, a second electrode; and an electrolytic solution arranged between the first electrode and the second electrode. The first electrode comprises a plurality of carbonaceous composite particles, wherein the carbonaceous composite particles can be the same or different and each composite particle comprises a graphite particle and a layer of ACS covering the graphite particle. The graphite particle is selected from a group consisting of a graphitized mesocarbon microbead, a natural graphite particle and a synthesized graphite particle. The size of the composite particle is preferably no more than 200 μm, more preferably no more than 100 μm, most preferably no more than 40 μm.

Yet another objective of the subject invention is to provide a lithium-ion secondary cell. The secondary cell comprises a cathode, an anode; and a electrolytic solution arranged between the first electrode and the second electrode. The cathode comprises a plurality of carbonaceous composite particles, wherein the carbonaceous composite particle can be the same or different and each composite particle comprises a graphite particle and a layer of ACS covering the graphite particle. The graphite particle is selected from a group consisting of a graphitized mesocarbon microbead, a natural graphite particle and a synthesized graphite particle. The size of the composite particle is preferably no more than 200 μm, more preferably no more than 100 μm, most preferably no more than 40 μm.

After reviewing the embodiments described hereinafter, persons having ordinary skills in the art underlying the subject invention can easily understand the basic spirit of the subject invention, other inventive objects, and the technical means and preferred embodiments adopted by the subject invention.

### BRIEF DESCRIPTION OF THE DRAWINGS

FIG. 1 shows an enlarged schematic structure diagram of the carbonaceous composite particle according to the subject invention.

FIG. 2 shows an assembled schematic diagram of one embodiment of the lithium-ion secondary cell according to the subject invention.

| | |
|---|---|
| 10 | graphite particle |
| 20 | layer of amorphous carbon structure |
| 100 | coin-type cell |
| 110 | cathode |
| 120 | cell base |
| 130 | separating membrane |
| 140 | anode |
| 150 | reed |
| 160 | washer |
| 170 | cell upper lid |

### DESCRIPTION OF THE PREFERRED EMBODIMENT

15 In the subject invention, a “graphite particle” means a particle with a graphite structure that can be a graphitized mesocarbon microbead, a natural graphite particle, or a synthesized graphite particle. A “covering” means a partial or entire coverage. In other words, the phrase “covering the particle” means that the entire or partial surface of the particle is covered.

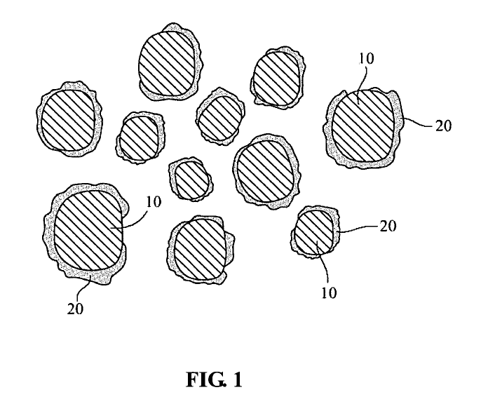

FIG. 1 shows a schematic diagram of the carbonaceous composite particle according to the subject invention. The carbonaceous composite particle comprises a graphite particle 10 and a layer of ACS 20 on the graphite particle 10. The layer of ACS 20 partially or entirely covers the graphite particle 10. For practical applications, the size of the composite particle is preferably no more than 200 μm, more preferably no more than 100 μm, and most preferably no more than 40 μm.

The carbonaceous composite particle can be formed by mixing the graphite particle and an ACS-forming material so that the ACS material coats the graphite particle. Thereafter, a heat treatment to the coated particle transforms the layer of the ACS-forming material into an ACS to provide the composite particle. Any materials that can provide an ACS with heat treatment can be used as the ACS-forming material. Preferably, the ACS-forming material is selected from a group consisting of phenol resin, furan resin, polyvinyl alcohol resin, polystyrene resin, polyimide resin, epoxy resin, cellulose resin, and a combination thereof.

The mixing proportions of the graphite particle and the ACS-forming material are not critical to the subject invention, as long as the ACS-forming material is in a mixing amount to partially or entirely cover the surface of the graphite particle. Generally, under the same amount of coverage, if the particle size of the graphite particle is smaller, the amount of the ACS-forming material is higher. If the particle size of the graphite particle is no more than 200 μm, the amount of the ACS-forming material ranges from 1 to 70 wt %, preferably from 10 to 60 wt %, based on the total weight of the graphite particle and the ACS-forming material.

Optionally, the ACS-forming material is dissolved in a solvent to obtain a solution. The solution is then mixed with the graphite particle to coat the ACS-forming material on the particle surface. If the selected ACS-forming material per se has fluidity, the material can be directly mixed with the graphite particle. For example, if a phenol resin is used as the ACS-forming material, the phenol resin can be directly mixed with the graphite particle. To achieve a uniform coverage, the mixing step can be conducted by stirring for a period ranging from 1 to 60 minutes.

Afterwards, the mixture comprising the ACS-forming material and the graphite particle is heated to transform the ACS-forming material into an ACS. At least two heat treatment steps are conducted in said heat treatment to accomplish the transformation. The first heat treatment removes the solvent which is optionally used in the mixing step and allows the ACS-forming material to crosslink and provides a crosslinked structure. The second heat treatment allows the crosslinked structure to further transform into the desired ACS.

The first heat treatment is conducted under a temperature that is not higher than the pyrolysis temperature of the ACS-forming material. Generally, the temperature should not be higher than 300□. Preferably, the first heat treatment is conducted in two stages. Particularly, the first stage is conducted at a temperature ranging from 40 to 120□ to remove the solvent which is optionally used in the mixing step and to cure the ACS-forming material to allow it to crosslink so as to provide a crosslinked structure. Optionally, the first stage can be conducted under vacuum for a period ranging from 5 minutes to 100 hours to enhance the removal of the solvent. Then, a second stage of stabilization is conducted at a temperature ranging from 150 to 300□ to allow the crosslinking of the ACS-forming material to be sufficiently conducted. Preferably, the stabilization is conducted under a temperature ranging from 180 to 250□ under an oxygen-containing atmosphere (e.g., air) for a period ranging from 5 minutes to 240 hours to sufficiently accomplish the crosslinking of the ACS-forming material.

The second heat treatment is conducted at a temperature higher than 400□ under an oxygen deficient atmosphere to carbonize the crosslinked structure from the ACS-forming material to form a layer of ACS on the surface of the graphite particle. Preferably, the carbonation is conducted at a temperature ranging from 500 to 1500□ with inert gas (e.g., nitrogen gas, helium gas, and/or argon gas) for a period ranging from 5 minutes to 10 hours. More preferably, the carbonation is conducted at a temperature ranging from 500 to 1000□.

Because the crosslinking reaction of the ACS-forming material allows the mixture to form a block product in the aforementioned heat treatment, the discrete form of the graphite particle may not exist. Therefore, a crushing treatment should be conducted before and/or after the second heat treatment step to reduce the product size so as to provide a product in the desired form.

Any common means for reducing particle size (e.g., mechanical crushing, bead milling, and grinding) can be used in the subject invention. For example, a crushing treatment can be conducted after the second heat treatment step. Or, prior to the second heat treatment step, the crosslinked product that has been subjected to the first heat treatment is first crushed to reduce its size and then subjected to carbonization in the second heat treatment. Preferably, the crushing treatment is conducted before and after the second heat treatment step to enhance the efficiency of the second heat treatment and provide the carbonaceous composite particle with a desired size. For example, a mechanical crushing treatment can be conducted before the second heat treatment to reduce the size of the block product obtained from the first heat treatment to facilitate the second heat treatment. Then, bead milling is conducted after the second heat treatment step to further reduce the product size so as to provide the desired particulate products.

A non-graphitized mesocarbon microbead also can be used as the raw material for the preparation of the carbonaceous composite particle of the subject invention. In this case, the second heat treatment can just be conducted at a temperature above 1500□, under which the mesocarbon microbead can be transformed into a graphitized mesocarbon microbead and the crosslinked structure from the ACS-forming material can be transformed into the ACS. Preferably, the second heat treatment is conducted in two stages: a first stage of carbonization at a temperature ranging from 500 to 1500□ and a second stage of graphitization at a temperature above 1500□. It is preferred for the carbonization to be conducted under an inert gas, such as nitrogen gas, helium gas, and/or argon gas at a temperature ranging from 500 to 1000□ for a period ranging from 5 minutes to 10 hours. It also preferred for the graphitization to be conducted under an inert gas, such as helium gas and/or argon gas at a temperature that is higher than 1500 and not higher than 3000□ (more preferably, at a temperature ranging from 2000 to 3000□) for a period ranging from 0.1 second to 240 hours.

The carbonaceous composite particle of the subject invention can be used in the manufacturing of electrodes required for the secondary cell in order to provide a secondary cell, especially a lithium-ion secondary cell. Therefore, the subject invention also provides a secondary cell which comprises a first electrode, a second electrode; and a electrolytic solution arranged between the first electrode and the second electrode. The first electrode contains a plurality of carbonaceous composite particles, wherein the carbonaceous composite particles can be the same or different from each other and each composite particle comprises a graphite particle and a layer of amorphous carbon structure covering the graphite particle. The graphite particle is selected from a group consisting of a graphitized mesocarbon microbead, a natural graphite particle and a synthesized graphite particle. The size of the composite particle is preferably no more than 200 μm, more preferably no more than 100 μm, and most preferably no more than 40 μm.

In the lithium-ion secondary cell according to the subject invention, the first electrode comprising a plurality of carbonaceous composite particles is used as the cathode and the second electrode is used as the anode. The anode can be made of any materials suitable for manufacturing an anode for a lithium-ion secondary cell. For example, lithium cobalt oxide (LiCoO₂), lithium nickel oxide (LiNiO₂), and/or lithium manganese oxide (LiMn₂O₄) can be used to provide the anode.

Any electrolytic solutions useful in lithium-ion secondary cells can be used in the lithium-ion secondary cell according to the subject invention. For example, the electrolytic solution of the lithium-ion secondary cell of the subject invention may utilize a lithium salt selected from the following group (but not limited to) as a solute: LiPF₆, LiBF₄, LiClO₄, LiAsF₆, LiCF₃SO₃, and a combination thereof. The electrolytic solution may also utilize a solvent selected from the following group (but not limited to): ethylene carbonate, propylene carbonate, ethyl methyl carbonate, dimethyl carbonate, and a combination thereof.

Preferably, in the lithium-ion secondary cell of the subject invention, LiPF₆ is used as the solute and a mixture formulated by ethylene carbonate/propylene carbonate/ethyl methyl carbonate/dimethyl carbonate in a volumetric ratio of 2.5-3.5/1/3.5-4.5/1.5-2.5 is used as the solvent, in order to provide a desired electrolyte solution.

The subject invention is further illustrated by the following embodiments. The true density of the carbonaceous composite particle produced by each example, the lithium-ion secondary cell for analysis, and the test of the secondary cell are respectively described as follows:

### (A) True Density of Carbonaceous Composite Particle

Equipment: Accupyc 1330 Pycnometwr True Densimeter (manufactured by Micromeritics GmbH)

Test method: The dried sample was put in the container of the true densimeter and weighted. The high pressure helium gas was introduced into the true densimeter. After an equilibrium status was achieved, the ideal gas equation (PV=nRT) was used to calculate the sample volume. Then, the average value of the sample density was obtained as the true density of the sample.

### (B) Manufacture of Coin-Type Lithium-Ion Secondary Cell

### (I) Cathode

An adhesive solid comprising the carbonaceous composite particles of the subject invention and polyvinylidene fluoride (“PVDF”) in a weight ratio of 9:1 was mixed with the solvent N-methylpyrrolidinone (“NMP”) with a solid/liquid ratio of 1:0.8 to form a slurry. The mixing sequence was as follow: 0.45% of oxalic acid based on the total weight of the slurry was first mixed with NMP, followed by mixing with PVDF for about 1.5 hours, so as to form the slurry. Oxalic acid was used to prevent the dissociation of fluoride ions in PVDF.

Afterwards, the above slurry was mixed with carbonaceous composite particles for about 1.5 hours to obtain a carbonaceous slurry. The carbonaceous slurry was coated on a copper foil by using a blade, and then the foil was put in a fuming hood and illuminated with an IR light to evaporate the solvent NMP. Thereafter, the coated copper foil was dried in a vacuum oven at a temperature of 80□ for 4 hours, followed by calendering the foil for densification to produce a densely compressed product. The densely compressed product was pressed to form a circle carbon electrode plate with a diameter of 1.2 cm, which was used as a cathode of the lithium-ion secondary cell.

### (II) Cell Assembly

1.15 moles of LiPF₆ were dissolved in a mixture of ethylene carbonate/propylene carbonate/ethyl methyl carbonate/dimethyl carbonate in a volumetric ratio of 3/1/4/2 to prepare the electrolytic solution.

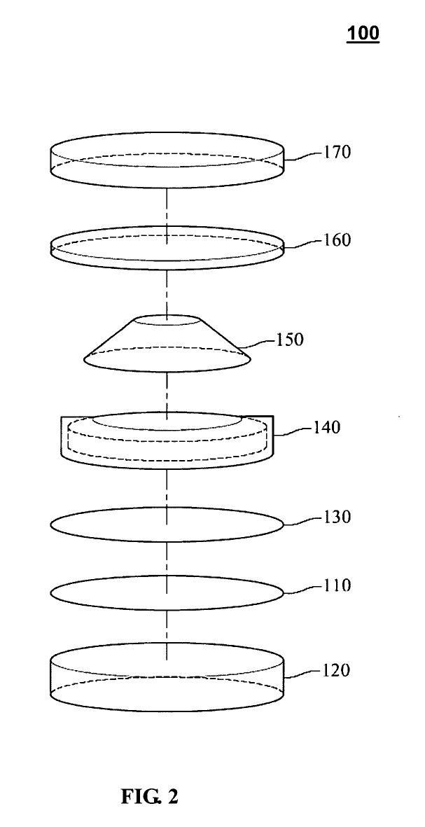

As shown in FIG. 2, a coin-type cell 100 was assembled. The carbon electrode plate for the cathode 110 was wetted with the electrolytic solution, and then was placed in the bottom of the cell base 120. Afterwards, a porous polyethylene (“PE”) separating membrane 130 was wetted with the electrolytic solution and then capped the plate 110. A proper amount of the electrolytic solution was then poured into the space between the plate 110 and the separating membrane 130. A stainless ingot that was covered with a lithium foil was installed (wherein the side covering with the lithium foil faces down) as the anode 140, and the reed 150 was placed to facilitate the cell compactness. Lastly, the gastight washer 160 was inserted and the cell upper lid 170 was placed, and then the cell was calendered to form a coin-type cell 100.

### (C) Charge-Discharge Tests of Cells

Equipment: Arbin BT2400 (manufactured by Arbin Instrument Inc., U.S.A.)

Test method: Charge-discharge cyclic tests were conducted according to the following steps:
(1) The open circuit potential of the assembled coin-type cell was tested with a high resistant meter to check if it was a short circuit.
(2) The carbon electrode of the tested cell connected to the anode and the cathode (reference electrode) was lithium metal.
(3) After turning on, the current and the potential scan rage were set. During charging, the cell was charged with a constant current of 0.05 Coulomb (1 Coulomb=320 mA/g) to 0.01 volt and then was charged with a constant voltage of 0.01 volt. During discharging, the cell was discharged with a constant current of 0.05 Coulomb to 1.8 volt.
(4) The capacity was calculated by using the voltage-current variations recorded in the computer.

### EXAMPLE 1

Graphitized mesocarbon microbeads (with a particle size ranging from 15 μm and 30 μm, manufactured by China Steel Chemical Corporation, No. MGP) were mixed with phenol resin (available from Chang Chun Corporation, No. PF650), and then sufficiently stirred for 15 minutes to obtain a mixture. The amount of the phenol resin is 40% of the total weight of the mixture.

The mixture was placed in a vacuum oven and cured under an atmosphere with the following heating curve: heating from 35□ to 70□ within 40 minutes and holding at 70□ for 90 minutes; heating from 70□ to 75□ within 30 minutes and holding at 75□ for 2 hours; heating from 75□ to 80□ within 20 minutes and holding at 80□ for 1 hour; and cooling from 80□ to 35□ within 1 hour. The above curing treatment allowed the phenol resin to crosslink so that the mixture formed a block.

The block was placed in a high temperature furnace for stabilization under air through the following heating curve: heating from 35□ to 230□ at a heating rate of 0.5 □/min and holding at 230□ for one hour; and cooling to room temperature at a cooling rate of 2 □/min. The purpose of the stabilization was to allow a sufficient crosslinking reaction in the phenol resin. Stabilization promotes the subsequent carbonization and graphitization so as to form a stable amorphous carbon structure with a good structure.

Thereafter, under the protection of nitrogen gas, the block was subjected to a heat treatment as follows: heating to 600□ at a heating rate of 0.5 □/min and holding at 600□ for 10 minutes, and cooling to room temperature at a cooling rate of 2 □/min. In this stage, the polymer structure of the phenol resin was transformed into a fragile glassy carbon structure.

Then, under nitrogen gas, the block was subjected to the following heat treatment: heating from the room temperature to 1000□ at a heating rate of 1 □/min and holding for 30 minutes. In this stage, the glassy carbon structure of the coating structure on the graphitized mesocarbon microbead was transformed into an amorphous carbon structure.

Next, the block composite was crushed into small blocks, and then small blocks were graphitized under the protection of an inert gas as follows: heating from the room temperature to 2500□ at a heating rate of 20 □/min, holding at 2500□ for 5 minutes, and then cooling to the room temperature at a cooling rate of 20 □/min.

Then, the graphitized product was bead milled and screened to obtain carbonaceous composite particles with a size ranging from 10 μm to 100 μm. The composite particle comprised the graphitized mesocarbon microbead and a layer of the amorphous carbon structure covering the microbead.

The physical property of the carbonaceous composite particles and the results of the charge-discharge test of the lithium-ion secondary cell provided thereby are listed in Table 1.

### EXAMPLE 2

The same raw materials and procedures as in Example 1 were used, except that the amount of the phenol resin was 45% of the total weight of the mixture. The physical property of the carbonaceous composite particles and the results of the charge-discharge test of the lithium-ion secondary cell are listed in Table 1.

### EXAMPLE 3

The same raw materials and procedures as in Example 1 were used, except that the graphitization was not conducted. The physical property of the carbonaceous composite particles and the results of the charge-discharge test of the lithium-ion secondary cell are listed in Table 1.

### EXAMPLE 4

The same heat treatments as in Example 1 were used, except that mesocarbon microbeads with an average particle size of 24 μm (manufactured by China Steel Chemical Corporation, No. GCSMB (UH-01-07)) were used as the raw material and the amount of the phenol resin was 33 wt % of the total weight of the mixture.

Moreover, for manufacturing a lithium-ion secondary cell in this example, the electrolytic solution was provided by dissolving 1 mole of LiPF₆ into a solvent formulated by ethylene carbonate/diethyl carbonate/propylene carbonate in a volumetric ratio of 3/5/2.

The physical property of the obtained carbonaceous composite particles and the results of the charge-discharge test of the lithium-ion secondary cell prepared thereby are listed in Table 1.

### COMPARATIVE EXAMPLE 1

The same raw materials and procedures as in Example 1 were used, except that no resin was used. The physical property of the obtained graphitized particles and the results of the charge-discharge test of the cell are listed in Table 1.

### COMPARATIVE EXAMPLE 2

A 100 percent resin (manufactured by Chang Chun Corporation, No. PF650) was used as the raw material. The other processes and test conditions are the same as those in Example 1. The physical property of the obtained graphitized resin particles and the result of the charge-discharge test of the cell are listed in Table 1.

TABLE 1

| | Second | Second | | | |
|---|---|---|---|---|---|
| | Charge | Discharge | Irreversible | Coulomb | Particle |
| | Capacity | Capacity | Capacity | Efficiency | Density |
| | (mAh/g) | (mAh/g) | (mAh/g) | (%) | (g/cm³) |
| Ex. 1 | 369.4 | 367.4 | 2 | 99.4 | 2.132 |
| Ex. 2 | 306.2 | 296.5 | 9.7 | 96.8 | 2.124 |
| Ex. 3 | 342.1 | 338.6 | 3.5 | 98.9 | 2.382 |
| Ex. 4 | 257.0 | 246.3 | 10.7 | 95.7 | 2.135 |
| Comp. Ex. 1 | 213.8 | 211.1 | 2.7 | 98.7 | 2.209 |
| Comp. Ex. 2 | 203.1 | 188.0 | 15.1 | 92.5 | 2.363 |

It can be known from Table 1, that as compared with conventional graphitized mesocarbon microbeads and graphitized resin particles, the carbonaceous composite particles according to the subject invention provide lithium-ion secondary cells with a better electrical property combination. Furthermore, the subject invention can attain a higher charge capacity and a lower irreversible capacity so as to provide a secondary cell with a longer cell life.

The above examples are used to illustrate the embodiments of the subject invention only, so as to state the technical features of the subject invention but not to limit the scope of the subject invention. Any changes or equal arrangements which can be easily accomplished by persons skilled in the technical features are within the scope claimed by the subject invention. The scope of protection of the subject invention should be based on the following claims as appended.

What is claimed is:

1. A carbonaceous composite particle, comprising:
a graphite particle; and
a layer of amorphous carbon structure covering the graphite particle,
wherein the graphite particle is a graphitized mesocarbon microbead, a natural graphite particle, or a synthesized graphite particle.

2. The composite particle of claim 1, wherein the graphite particle is graphitized mesocarbon microbead.

3. The composite particle of claim 1, which has a size of no more than 100 μm.

4. The composite particle of claim 1, which has a size of no more than 40 μm.

5. A method for manufacturing a carbonaceous composite particle, comprising the steps:
(a) mixing a plurality of carbonaceous particles and an amorphous carbon structure (ACS)-forming material to provide a mixture, wherein the carbonaceous particle is the same or different from each other and is either a mesocarbon microbead or a graphite particle, while the graphite carbon is a graphitized mesocarbon microbead, a natural graphite particle, or a synthesized graphite particle;
(b) conducting a first heat treatment under a temperature that is not higher than the pyrolysis temperature of the ACS-forming material; and
(c) conducting a second heat treatment under oxygen deficient atmosphere;
wherein a crushing treatment is conducted before and/or after the second heat treatment step (c).

6. The process of claim 5, wherein the ACS-forming material is selected from a group consisting of phenol resin, furan resin, polyvinyl alcohol resin, polystyrene resin, polyimide resin, epoxy resin, cellulose resin, and a combination thereof.

7. The process of claim 5, wherein the first heat treatment step (b) comprises heating the mixture at a temperature that is not higher than 300° C.

8. The process of claim 7, wherein the first heat treatment step (b) comprises:
a curing treatment at a temperature ranging from 40□ to 120□; and
a stabilization at a temperature ranging from 150□ to 300□ under an oxygen-containing atmosphere.

9. The process of claim 5, wherein the second heat treatment step (c) comprises the carbonization of the mixture at a temperature ranging from 500□ to 1500□.

10. The process of claim 9, wherein the second heat treatment step (c) further comprises the graphitization of the carbonized mixture at a temperature that is higher than 1500□ and not higher than 3000□.

11. The process of claim 10, wherein the graphitization is conducted at a helium gas or argon gas atmosphere.

12. The process of claim 5, wherein the crushing is conducted by bead milling.

13. The process of claim 10, wherein a crushing treatment is conducted before the carbonization treatment and a bead milling is conducted after the graphitization.

14. A secondary cell, comprising:
a first electrode comprising a plurality of carbonaceous particles, wherein the carbonaceous composite particle can be the same or different from each other and comprises a graphite particle and a layer of amorphous carbon structure covering the graphite particle, and the graphite particle is selected from a group consisting of a graphitized mesocarbon microbead,
a natural graphite particle and a synthesized graphite particle,;
a second electrode; and
an electrolytic solution arranged between the first electrode and the second electrode.

15. The secondary cell of claim 14, wherein the graphite particle is a graphitized mesocarbon microbead.

16. The secondary cell of claim 14, wherein the composite particle has a size of no more than 100 μm.

17. The secondary cell of claim 14, wherein the composite particle has a size of no more than 40 μm.

18. The secondary cell of claim 14, which is a lithium-ion secondary cell and wherein the first electrode is a cathode and the second electrode is an anode.

19. The secondary cell of claim 18, wherein the electrolytic solution comprises an electrolyte selected from a group consisting of LiPF₆, LiBF₄, LiClO₄, and a combination thereof.

20. The secondary cell of claim 18, wherein the electrolytic solution comprises a solvent selected from a group consisting of ethylene carbonate, propylene carbonate, ethyl methyl carbonate, dimethyl carbonate, and a combination thereof.

21. The secondary cell of claim 18, wherein the electrolytic solution comprises ethylene carbonate, propylene carbonate, ethyl methyl carbonate, and dimethyl carbonate in a volumetric ratio of 2.5-3.5:1:3.5-4.5:1.5-2.5.
